(19) United States
(12) Patent Application Publication
(10) Pub. No.: US 2012/0057154 A1
(43) Pub. Date: Mar. 8, 2012

(54) OPTICAL MEASURING SYSTEM WITH MATCHED COLLECTION LENS AND DETECTOR LIGHT GUIDE

(76) Inventors: Andrei Brunfeld, Cupertino, CA (US); Bryan Clark, Mountain View, CA (US); Gregory Toker, Jerusalem (IL); Morey T. Roscrow, Milpitas, CA (US)

(21) Appl. No.: 12/877,480

(22) Filed: Sep. 8, 2010

(51) Int. Cl. G01N 21/88

(52) U.S. Cl. 356/237.2

(57) ABSTRACT

An optical surface inspection system provides dark-field detection avoiding ghost images and without capturing, stray, reflected or re-scattered light. The system includes an illumination system that generates an illumination spot on a surface under inspection collecting lens that collects substantially all light scattered from the surface under inspection from the illumination spot. The system also includes a light guide with a first end having a numerical aperture matched to an exit aperture of the collecting lens and a field of view matched to the illumination spot, and a second end coupled to a detector.

The present Application is related to co-pending U.S. patent application entitled “OPTICAL MEASURING SYSTEM WITH ILLUMINATION PROVIDED THROUGH A VOID IN A COLLECTING LENS” filed contemporaneously herewith by the same inventors, and which is incorporated herein by reference.

### BACKGROUND OF THE INVENTION

1. Field of the Invention

This invention relates to optical measurement and inspection systems, and more specifically, to an optical inspection head and system in which a collection lens has a numerical aperture matched to a detector light guide.

2. Background of the Invention

Optical surface inspection systems are in common use in industry for both analysis and manufacturing test operations. The detection systems are either bright-field, i.e., systems that detect a change in intensity of an optical beam from some maximum value, or dark-field, i.e., systems that detect an absolute intensity of detected light above a background value of zero.

Dark field detectors are highly desirable, as their dynamic range is potentially infinite and their sensitivity is theoretically limited only by the resolution and linearity of the detector. However, dark field detectors are sensitive to stray light sources and leakage along the optical path. In particular, scattering detectors or scatterometers, are extremely sensitive to parasitic light originating in so-called “ghost images” in the optical system, and to reflection and rescattering of ambient light.

While it is possible to isolate an optical system from ambient light sources, the resulting enclosed system is typically much more expensive, is larger and has other disadvantages due to the enclosure.

Therefore, it would be desirable to provide an optical system that prevents the generation and capture of stray light, such as ghost images.

### SUMMARY OF THE INVENTION

The foregoing objectives are achieved in an optical system and method for optical inspection. The inspection system includes an illumination system that generates an illumination spot on a surface under inspection and a large numerical aperture collecting lens that collects substantially all light scattered from the surface under inspection from the illumination spot. The system also includes a light guide having a first end, with a numerical aperture matched to an exit aperture of the collecting lens and a field of view matched to the illumination spot, and a second end coupled to a detector.

The light guide may be an optical fiber, a hollow tubular guide with a non-reflecting interior, a baffled tube or other suitable light guide structure. The illumination system may direct a beam through a void passing through the collecting lens, to prevent generation of any ghost image by the collecting lens.

The foregoing and other objects, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting an optical inspection system in accordance with an embodiment of the present invention.

FIG. 2 is a pictorial diagram depicting an optical system in accordance with an embodiment of the present invention.

FIG. 3 is a pictorial diagram depicting an optical system in accordance with another embodiment of the present invention.

FIGS. 4A-4C are pictorial diagram depicting light guides that may be employed in the systems of FIGS. 2-3.

FIG. 5 is a pictorial diagram depicting an optical system in accordance with yet another embodiment of the present invention.

### DESCRIPTION OF ILLUSTRATIVE EMBODIMENT

The present invention encompasses scattering-based optical inspection systems in which a large numerical aperture lens is used to capture substantially all the light scattered from an illumination spot on a surface under inspection. The exit aperture of the lens is matched to a light guide that directs the collected light to a detector, providing a system in which collection of stray light, i.e., light other than the light collected by the lens or light from outside is prevented from reaching the detector. Other techniques may be included in combination, such as directing illumination through a void passing through the collecting lens, preventing generation of ghost images that may enter the scatterometer detection path.

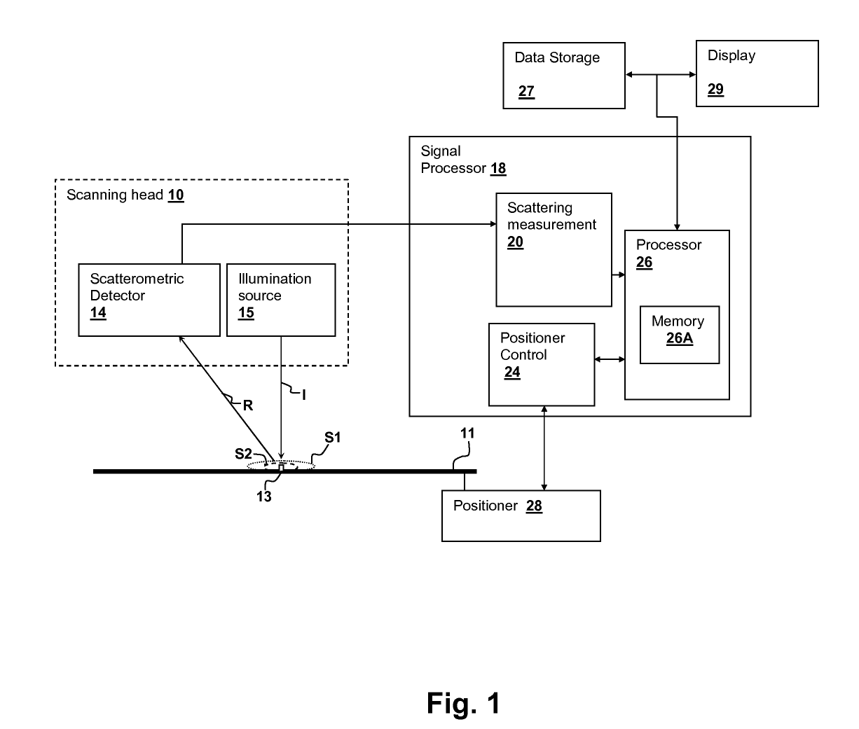

Referring now to FIG. 1, an optical inspection system in accordance with an embodiment of the present invention is shown. A scanning head 10 is positioned over a surface under inspection 11, which is moved via a positioner 28 that is coupled to a signal processor 18. From scanning head 10, illumination I of surface under inspection 11 is provided by an illumination source 15. A scattering detector 14 receives light scattered from surface under inspection 11 along optical path R from an illumination spot S generated by illumination I. Scatterometric optical path R gathers light from one or more non-specular angles with respect to illumination I and surface under inspection 11, so that light scattered from an artifact 13 (which may be a surface defect or feature, or an extraneous particle) disposed on surface under inspection 11, indicates the presence of the artifact.

In contrast to typical scatterometric systems, in the scatterometric channel of the inspection system depicted in FIG. 1, which may include other optical channels, substantially all of the light scattered from illumination spot S is collected by scatterometric detector 14, which includes a large numeric aperture lens as will be described in further detail below. Collecting substantially all of the scattered light increases the sensitivity of the dark-field approached used in scatterometric detector 14, and other techniques used within the optical inspection system are employed to prevent the detection of anything other than light scattered from illumination spot S by articles or defects present on surface under inspection 11.

While the illustration shows a positioner 28 for moving surface under inspection under scanning head 10, it is understood that scanning head 10 can be moved over a fixed surface, or that multiple positioners may be employed, so that both scanning head 10 and surface under inspection 11 may be moved in the measurement process. Further, while scattering detector 14 and illumination source 15 are shown as included within scanning head 10, optical fibers and other optical pathways may be provided for locating scattering detector 14 and illumination source(s) 15 physically apart from scanning head 10.

Signal processor 18 includes a processor 26 that includes a memory 26A for storing program instructions and data. The program instructions include program instructions for controlling positioner 28 via a positioner control circuit 24, and performing measurements in accordance with the output of scatterometric detector 14 via scatterometer measurement circuit 22A that include signal processing and analog-to-digital conversion elements as needed for receiving the output of scatterometric detector 14. A dedicated threshold detector 20 can be employed to indicate to processor 26 when scattering from an artifact 13 on surface under measurement 11 has been detected above a threshold. As an alternative, continuous data collection may be employed. Processor 26 is also coupled to an external storage 27 for storing measurement data and a display device 29 for displaying measurement results, by a bus or network connection. External storage 27 and display device 29 may be included in an external workstation computer or network connected to the optical inspection system of the present invention by a wired or wireless connection.

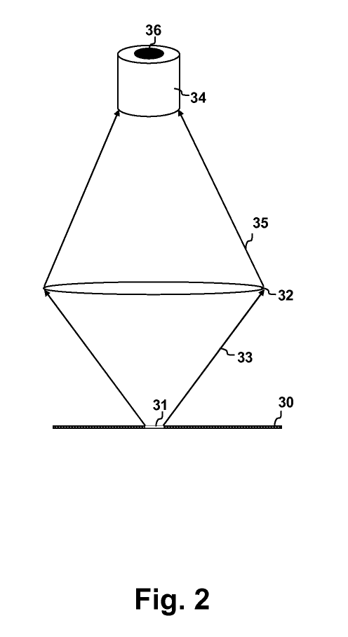

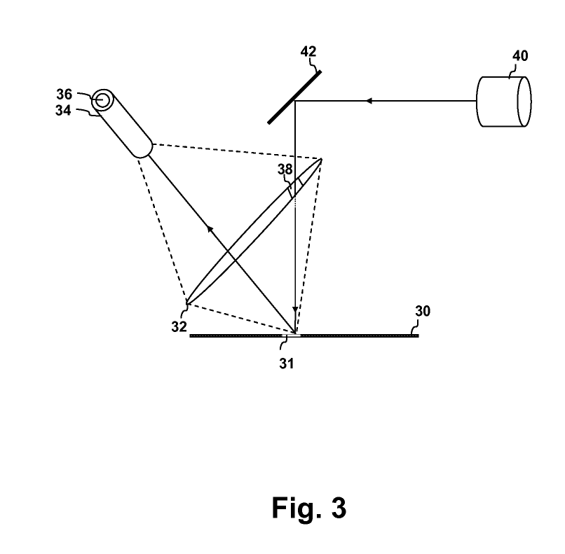

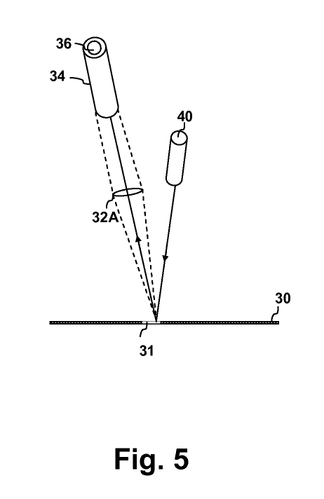

Referring now to FIG. 2, an optical system in accordance with an embodiment of the present invention is shown, which may be included within scatterometric detector 14 of FIG. 1. A specific illumination source is not illustrated, other than an illumination spot 31 is produced on a surface under inspection 30. The system illustrated in FIG. 2 is an example of a system in accordance with the present invention, in which a large numerical aperture collecting lens 32 is positioned above a surface under inspection 30 so that substantially all light scattered by artifacts on surface under inspection 30 within illumination spot 31 is captured by collecting lens 32 and directed toward an optical guide 34 that provides the light to the a detector 36. Rays 33 represent the angular boundary of the aperture of collecting lens 32, and the proximity of lens 32 to surface under inspection 30 will govern the amount of scattered light captured by collecting lens 32. Rays 33 illustrate the boundary of the captured field of spot 31 in the exit aperture of collecting lens 32, which is matched to the numerical aperture of light guide 34, which may be the actual aperture, or if a lens is employed at the proximal end of light guide 34, such as a shaped and polished end of an optical fiber, then the numerical aperture of the lens is matched to the exit numerical aperture of collecting lens 32. In the system depicted in FIG. 2, and also the further embodiments described below and shown in FIG. 3 and FIG. 5, non-imaging optics is employed, i.e., the collecting lens and light guide do not image illumination spot 31 at detector 34, but rather, all rays leaving illumination spot 31 that strike collecting lens 32 are directed into light guide 34 without the constraint of preserving an image of illumination spot 31.

Referring now to FIG. 3, an optical system in accordance with another embodiment of the present invention is shown, which may be included within scatterometric detector 14 of FIG. 1. In the depicted embodiment, an illumination source 40 is positioned over surface under inspection 30 and the illumination beam produced by illumination source 40 is directed at surface of interest to produce illumination spot 31 by bending mirror 42. The illumination beam is directed through a void 38 passing through a collecting lens 32, so that no ghost reflections are generated by scattering off of surfaces of, or material internal to, collecting lens 32. Collecting lens 32 is rotated at an angle other than the direction of the illumination beam, so that spatial separation is provided between the axes of the illumination and the scattered light being detected. Void 38 is in the form of a slit in collecting lens 32, but may take other forms and may be located at an edge of collecting lens 32. Light scattered by artifacts within illumination spot 31 is collected by collecting lens 32, which has a large numerical aperture. The exit aperture of collecting lens 32 is matched to the entrance aperture of light guide 34, which delivers substantially all of the scattered light captured by collecting lens to detector 36. Further details of suitable collecting lenses and different arrangements for providing illumination through a collecting lens, as well as technique that make measurements on light returned through a collecting lens void are illustrated in the above-incorporated U.S. Patent Application “OPTICAL MEASURING SYSTEM WITH ILLUMINATION PROVIDED THROUGH A VOID IN A COLLECTING LENS.” The techniques disclosed therein may be used in conjunction or alternative to the techniques disclosed herein.

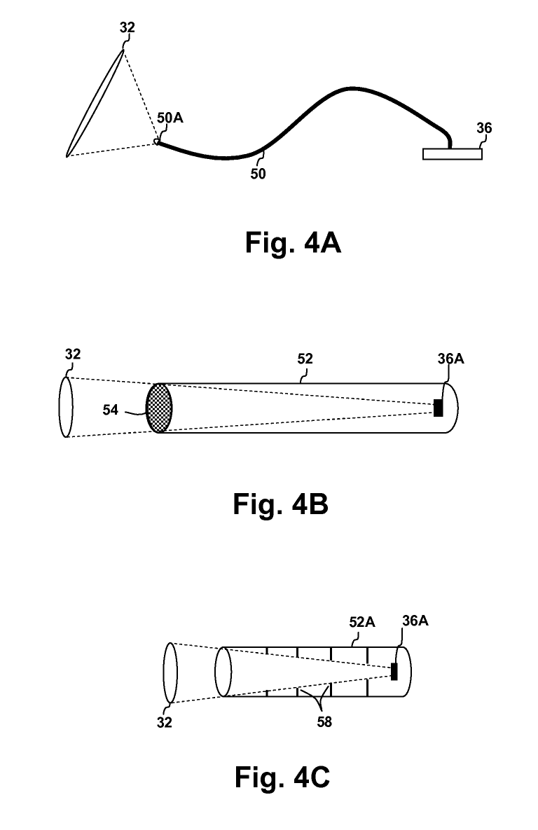

Referring now to FIG. 4A, details of an optical guide that may be used to implement light guide 34 of the optical systems of FIGS. 1-3 (and also in FIG. 5 described below) is shown. An optical fiber 50 has a polished proximal end 50A shaped to form a lens matching the exit aperture of collecting lens 32. The distal end of optical fiber 50 is coupled to detector 36. The design of optical fiber 50 can be such that light entering fiber 50 beyond a particular angle with respect to the longitudinal axis of fiber 50 is damped within the first portion of fiber 50.

Referring now to FIG. 4B, details of another optical guide that may be used to implement light guide 34 of the optical systems of FIGS. 1-3 (and also in FIG. 5 described below) is shown. A hollow tube 52 having a light-absorbing inner surface 54 is optimized so that the optical aperture of hollow tube 52 is matched to the exit aperture of collecting lens 32 and delivers substantially all of the light collected by collecting lens 32 to detector 36A, while avoiding collection of any stray light.

Referring now to FIG. 4C, details of still another optical guide that may be used to implement light guide 34 of the optical systems of FIGS. 1-3 (and also in FIG. 5 described below) is shown. A hollow tube 52A having baffles 58 is optimized so that the optical aperture of hollow tube 52A is matched to the exit aperture of collecting lens 32 and delivers substantially all of the light collected by collecting lens 32 to detector 36A, while avoiding collection of any stray light. Baffles 58 have a progressively decreasing inside diameter in the direction toward detector 36A and have absorptive surfaces, so that reflections off of baffles 58 and the inner wall of hollow tube 52A are reduced. Any reflected energy that remains will be further directed away from detector 36A. Therefore only rays that enter the first one of baffles 58 within a predetermined angle (cone) with respect to the longitudinal axis of the light guide will be directed to detector 36A.

Referring now to FIG. 5, an optical system in accordance with yet another embodiment of the present invention is shown, which may be included within scatterometric detector 14 of FIG. 1. The depicted embodiment is similar to that of FIG. 3, so only differences between them will be pointed out below. In the optical system of FIG. 5, illumination source 40 is directed at surface under inspection 30 and the illumination beam produced by illumination source 40 produces illumination spot 31 directly, without mirrors or passing through collecting lens 32A. Light scattered by artifacts within illumination spot 31 is collected by collecting lens 32A, which has a large numerical aperture. The exit aperture of collecting lens 32A is matched to the entrance aperture of light guide 34, which delivers substantially all of the scattered light captured by collecting lens to detector 36.

While the invention has been particularly shown and described with reference to the preferred embodiments thereof, it will be understood by those skilled in the art that the foregoing and other changes in form and details may be made therein without departing from the spirit and scope of the invention.

What is claimed is:

1. An optical inspection system, comprising:
an illumination subsystem for directing an illumination beam at a surface under inspection to generate an illumination spot at the surface under inspection;
a collecting lens for collecting light from the surface under inspection, wherein the collecting lens has a large numerical entrance aperture such that substantially all of the light scattered from the surface under inspection from the illumination spot is collected by the collecting lens;
a light guide having a first end with a numerical aperture matched to an exit numerical aperture of the collecting lens and having a field of view substantially matching the area of the illumination spot; and
a detector coupled to a second end of the light guide for detecting light collected by the collecting lens.

2. The optical inspection system of claim 1, wherein the light guide receives substantially all of the light scattered into the collecting lens from the illumination spot, without generating an image of the illumination spot in the light guide.

3. The optical inspection system of claim 1, wherein the light guide is an optical fiber.

4. The optical inspection system of claim 3, wherein stray light other than the light collected by the collecting lens that enters the optical fiber is damped before reaching the detector.

5. The optical inspection system of claim 3, wherein the optical fiber has a polished end shaped to match the exit aperture of the collecting lens.

6. The optical inspection system of claim 1, wherein the light guide is a straight tubular guide having the collecting lens mounted at the first end thereof.

7. The optical inspection system of claim 6, wherein the light guide further comprises baffles disposed along the length of the tubular guide and having light absorbing surfaces.

8. The optical inspection system of claim 1, wherein the collection lens defines a void passing through the collection lens and devoid of any lens material and wherein the illumination subsystem directs the illumination beam through the void to generate the illumination spot at the surface under inspection.

9. The optical inspection system of claim 8, wherein the void is a slit in the collecting lens having two substantially parallel sides extending across the collecting lens in a plane perpendicular to the optical axis of the collecting lens.

10. A method of performing an optical inspection, comprising:
directing an illumination beam at a surface under inspection to generate an illumination spot at the surface under inspection;
collecting light from the surface under inspection with a collecting lens, wherein the collecting lens has a large numerical entrance aperture such that substantially all of the light scattered from the surface under inspection from the illumination spot is collected by the collecting lens;
capturing light leaving the collecting lens with a light guide having a first end with a numerical aperture matched to an exit numerical aperture of the collecting lens and having a field of view substantially matching the area of the illumination spot; and
detecting an intensity of the light captured by the capturing with a detector.

11. The method of claim 10, wherein the capturing captures substantially all of the light scattered into the collecting lens from the illumination spot, without generating an image of the illumination spot in the light guide.

12. The method of claim 10, wherein the light guide is an optical fiber.

13. The method of claim 12, wherein stray light other than the light collected by the collecting lens that enters the optical fiber is damped before reaching the detector.

14. The method of claim 12, wherein the optical fiber has a polished end shaped to match the exit aperture of the collecting lens.

15. The method of claim 10, wherein the light guide is a straight tubular guide having the collecting lens mounted at the first end thereof.

16. The method of claim 15, further comprising absorbing stray light within the tubular guide by providing absorbing baffles disposed along the length of the tubular guide.

17. The method of claim 10, wherein the directing directs the illumination beam through a void passing through the collection lens and devoid of any lens material.

18. The method of claim 17, wherein the void is a slit in the collecting lens having two substantially parallel sides extending across the collecting lens in a plane perpendicular to the optical axis of the collecting lens.

19. An optical inspection system, comprising:
an illumination subsystem for directing an illumination beam at a surface under inspection to generate an illumination spot at the surface under inspection;
a collecting lens for collecting light from the surface under inspection, wherein the collecting lens has a large numerical entrance aperture such that substantially all of the light scattered from the surface under inspection from the illumination spot is collected by the collecting lens, and wherein the collection lens defines a void passing through the collection lens and devoid of any lens material and wherein the illumination subsystem directs the illumination beam through the void to generate the illumination spot at the surface under inspection;
an optical fiber light guide having a first end shaped to provide a numerical aperture matched to an exit numerical aperture of the collecting lens and having a field of view substantially matching the area of the illumination spot; and
a detector coupled to a second end of the light guide for detecting light collected by the collecting lens.

20. The optical inspection system of claim 19, wherein the void is a slit in the collecting lens having two substantially parallel sides extending across the collecting lens in a plane perpendicular to the optical axis of the collecting lens.
